(19) United States
(12) Patent Application Publication
(10) Pub. No.: US 2003/0030561 A1
(43) Pub. Date: Feb. 13, 2003

(54) Method and apparatus for wireless tracking and communication

(76) Inventors: Byron Yafuso, San Diego, CA (US); Kayla R. Seignious, Lakeside, CA (US)

Correspondence Address: Sarah Kirkpatrick, Intellectual Property Administration, QUALCOMM Incorporated, 5775 Morehouse Drive, San Diego, CA, 92121-1714, US

(21) Appl. No.: 09/925,104

(22) Filed: Aug. 8, 2001

(51) Int. Cl. G08B 23/00

(52) U.S. Cl. 340/573.4; 340/539

(57) ABSTRACT

A positional tracking system including a mobile unit is disclosed which may be disposed in a pre-determined coverage area, such as an amusement park. The mobile unit may send an alert message to a dispatch center or parent units if the mobile unit enters locations defined by forbidden coordinates. The mobile unit may function only within the a coverage area, and thus park patrons will have little incentive to remove mobile units from the coverage area. A dispatch center may determine when the mobile unit leaves the coverage area and notify a parent unit. Additionally, the mobile unit can automatically sound an audible alert when leaving the coverage area.

### BACKGROUND OF THE INVENTION

I. Field

The present invention relates to wireless tracking and communication. More particularly, the present invention relates to a novel and improved personal tracking apparatus and method utilizing CDMA techniques.

II. Background

Keeping track of one's children in an amusement park can be a very challenging task, as any parent is well aware. With all of the distractions present at amusement parks, parents may spend more time accounting for their children than actually enjoying the visit.

Parents face many challenges at an amusement park. For example, during the excitement of a visit, parents may lose communication with their children because of the large crowds and lines present at amusement parks.

Parents of larger families, especially families with older children, face additional challenges at an amusement park. As children get older, their interests are often different from those of their younger siblings. Older children will often desire to visit different attractions than the rest of the family. Larger families may thus split into smaller groups to allow each group to visit the attractions of their choice. However, parents may be reluctant to allow groups to separate if their no means for communication available.

For example, parents may wish to be able to contact their children to meet at a pre-arranged time, or to check on their status. Likewise, the children may wish to contact their parents (or group leader, if the children are on a school trip, for example) if they get lost, or wish to change plans.

Modern wireless technology has helped this situation, but technologies available today are still deficient in certain areas.

For example, young children may be unable to properly operate a cellular phone, or read a pager. Young children may be unable to remember phone numbers or pager codes. Moreover, cellular phones and pagers may get lost or stolen in an amusement parks.

Furthermore, cellular phones and pagers are unable to assist in the determination of the location of children.

Hence, there is a need for an improved wireless tracking and communication system that solves the deficiencies of the prior art.

### SUMMARY

A mobile unit configured to communicate with a wireless dispatch center is disclosed. In one disclosed aspect, the mobile unit may include a wearable enclosure; a transmitter and receiver disposed within the enclosure; a position location processor configured to analyze signals received from the dispatch center through the receiver and determine the location of the mobile unit; and a strap for attaching the enclosure to a wearer, wherein the position location processor is configured to detect when the strap is disconnected and notifies the dispatch center of the disconnection using a signal transmitted from the transmitter.

A communication system for tracking individuals is also disclosed. In one aspect, the system may include a dispatch center operatively coupled to a transmitter and a plurality of antennae deployed about a predetermined area; a charger/programming interface operatively disposed within the dispatch center and configured to receive one or more mobile units, wherein the interface is configured to program said mobile units with predetermined coordinates.

A method for tracking a mobile unit is also disclosed. In one aspect, the method may include storing forbidden coordinates into the mobile unit; comparing, the mobile unit, the location of the mobile unit to the forbidden coordinates; and notifying a dispatch center, if the mobile unit is proximate to the forbidden coordinates.

In further aspect, the system may be disposed within a predetermined coverage area, such as an amusement park. In a further aspect, the mobile unit is configured to operate only within the park's infrastructure system, thus discouraging theft of the mobile unit. A mobile unit may determine when it leaves the peak area and notify the dispatch center. Additionally, the mobile unit can automatically sound an audible alert when leaving the park area.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 is a flowchart of a method of one aspect of a disclosed system;

FIG. 2A is a functional block diagram of one aspect of a disclosed a mobile unit according;

FIG. 2B is a side view of another aspect of a mobile unit;

FIG. 2C is a perspective view of a one aspect of a disclosed mobile unit;

FIG. 2D is an operational block diagram of one aspect of a disclosed mobile unit;

FIG. 3 is a functional block diagram of one aspect of a disclosed wireless communication system;

FIG. 4A is a operational block diagram of a wireless communication system;

FIG. 4B is a block diagram of one aspect of a disclosed a dispatch center;

FIG. 5 is a simplified representation of one aspect of a disclosed wireless communications system;

FIG. 6 is an operational block diagram of one aspect of a disclosed base station; and

FIG. 7 is a flowchart of an alternative embodiment of one aspect of a disclosed system.

### DETAILED DESCRIPTION

Persons of ordinary skill in the art will realize that the following description of the various embodiments of the present invention is illustrative only and not in any way limiting. Other embodiments of the invention will readily suggest themselves to such skilled persons having the benefit of this disclosure.

It is contemplated that the described methods may be embodied in various computer and machine readable data structures. Furthermore, it is contemplated that the disclosed data structures embodying the present invention may be transmitted across computer and machine-readable media, and through communications systems by use of standard protocols such as those used to enable CDMA-based communication systems.

Additional embodiments include machine-readable media on which are stored the methods disclosed herein. It is contemplated that any media suitable for storing instructions related to the present invention is within the scope of the present invention. For example, such media may take the form of magnetic, optical, or semiconductor media.

The various embodiments are described through the use of flowcharts. Often, a single instance of an embodiment of the present invention will be shown. As is appreciated by those of ordinary skill in the art, however, the protocols, processes, and procedures described herein may be repeated continuously or as often as necessary to satisfy the needs described herein.

Exemplary embodiments of disclosed apparatus and methods may be disclosed herein. The word “exemplary” is used herein to mean “serving as an example, instance, or illustration.” Any embodiment described as an “exemplary embodiment” is not to be construed as necessarily preferred or advantageous over other embodiments described herein.

Method and Overview

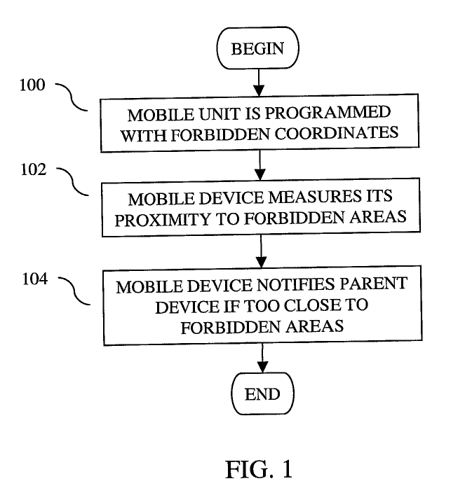

Referring now to FIG. 1, a flowchart of a method according to an aspect of a preferred embodiment is shown.

The process of FIG. 1 begins with step 100, where a mobile unit is programmed with coordinates of forbidden areas throughout a predetermined coverage area. For example, if the predetermined area encompasses an amusement park, the forbidden areas may represent park exits or attractions that a child is not allowed to visit.

In step 102, a mobile unit receives signals and timing information from the system and determines the location based on the signals and information and periodically measures and compares its location against the forbidden coordinates.

In step 104, if the mobile unit determines that it is too close to a forbidden area, the device may notify a parent device or dispatch center.

Mobile Unit

The structure of various aspects of the present invention will now be disclosed and described.

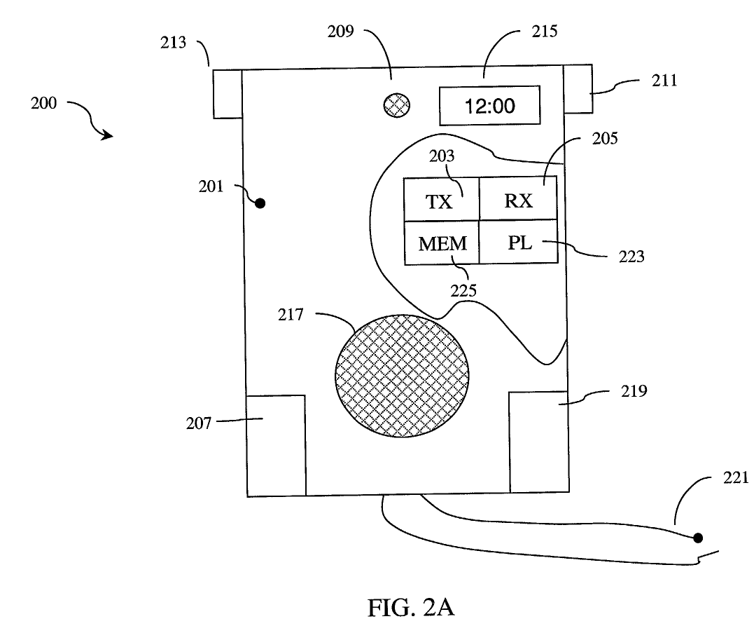

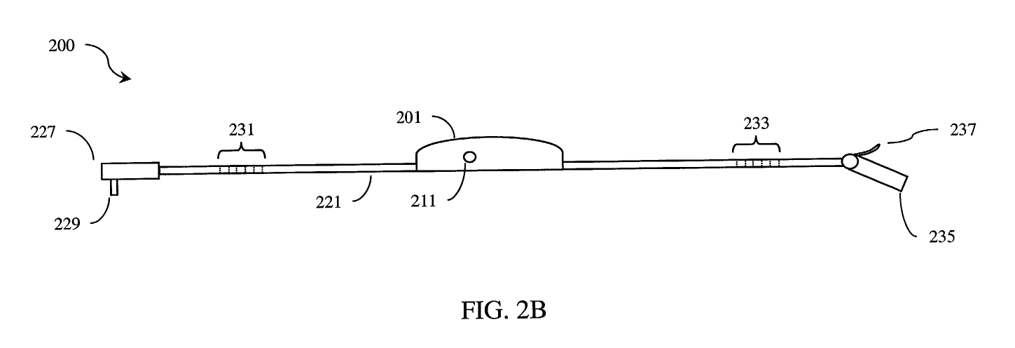

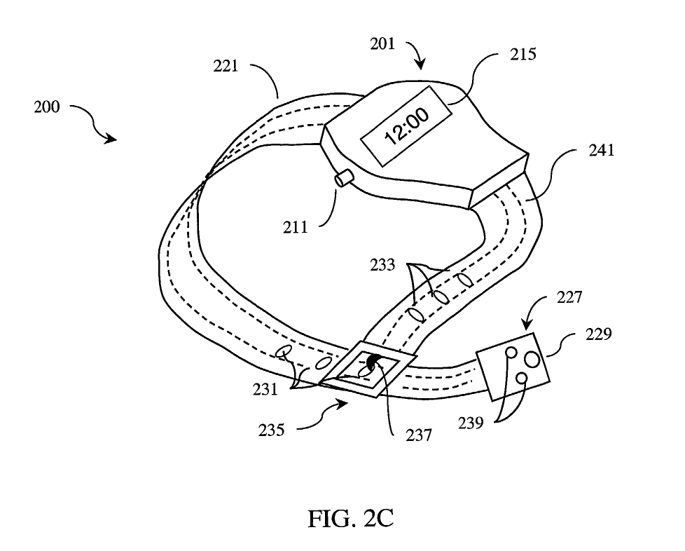

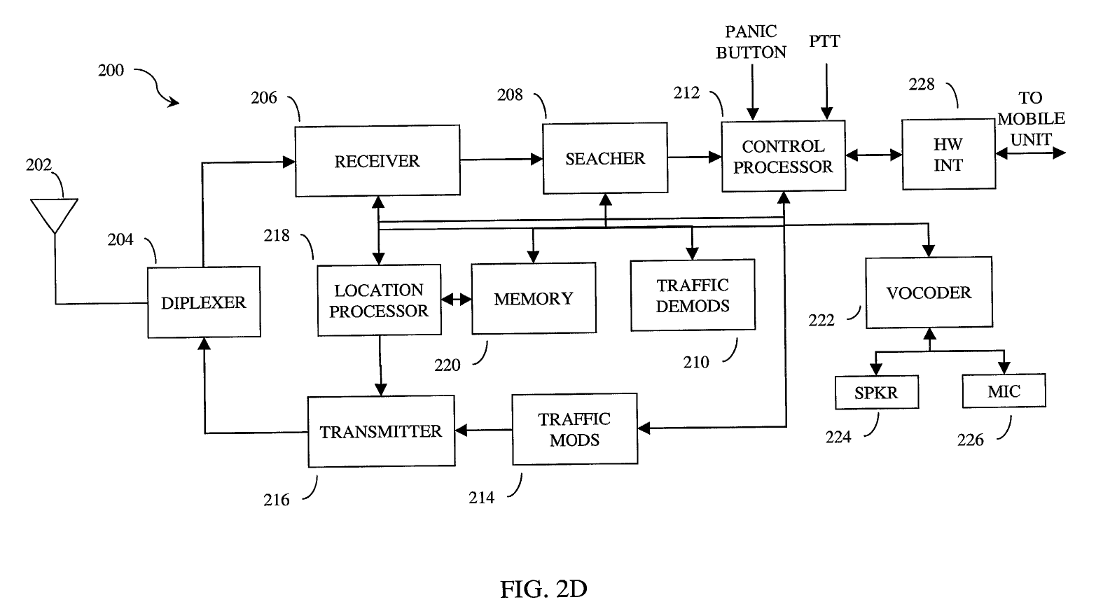

Referring now to FIG. 2A, a conceptual diagram of a mobile unit 200 is shown. Mobile unit 200 includes an enclosure 201. In an exemplary embodiment, the enclosure 201 is small enough to be worn on the body, e.g., suitable for a small child to wear on a wrist or around the waist. For example, in an exemplary embodiment, the enclosure 201 comprises a size or shape comparable to a watch. In an exemplary embodiment, enclosure 201 comprises a wearable shape configured to attach to the body of a person. It is contemplated that the enclosure 201 may be attached to the wearer's body through attachment means such as a wristband, belt, or other means.

Mobile unit 200 further includes transmitting means (TX) 203 and receiving means (RX) 205. TX 203 and RX 205 are shown operatively disposed within enclosure 201 in FIG. 2A. In an embodiment, mobile unit 200 may transmit location information to a dispatch center. The mobile unit 200 transmits this information through TX 203, for example, when it determines that its location is within a forbidden area. The dispatch center then determines the location of the mobile unit based on the received information. In an embodiment, the dispatch center determines the location of the mobile unit from the signal received from the mobile unit. In an alternate embodiment, the dispatch center exchanges additional signals with the mobile unit to maintain more exact coordinates of the mobile unit, or to track movements of the mobile unit.

In an exemplary embodiment, TX 203 is configured to enable voice communications in a push-to-talk mode similar to operation of a walkie-talkie. For example, mobile unit 200 may further be configured to communicate to one or more other complimentary mobile units. To facilitate such a walkie-talkie format, the mobile unit 200 may further include a speaker 207 and a microphone 209. Speaker 207 and microphone 209 may both comprise means well known in the art and are operatively coupled to TX 203 and RX 205. It will be recognized by those skilled in the art that many input/output paradigms may be used, including voice initiated input.

Mobile unit 200 may further include a push-to-talk (PTT) button 213, which is configured to facilitate communications among two or more users. It is contemplated that the present invention may be configured such that PTT communications among multiple disjoint groups of mobile units may be arbitrated by a network manager in a dispatch center. It is further contemplated that such a network manager may be configured to enable sub-nets of mobile units to be defined in net broadcast mode as will be described in more detail below.

Mobile unit 200 may further include a panic button 211. In an exemplary embodiment, mobile unit 200, and in particular TX 203, is configured to provide a panic button for use in emergencies. In an exemplary embodiment, when the panic button 211 is activated, the mobile unit 200 will automatically contact a dispatch center, which may then contact the child's parent or guardian. In yet an exemplary embodiment, the present invention may be configured to contact a complimentary unit which may be carried by the child's parent or guardian. In such an embodiment, a voice link may be set up, or an alert may be sounded, such as an audible or vibrational alert. Note that the panic button 211 and PTT button may alternatively be located in places on the mobile unit other than as shown.

Mobile unit 200 may also include a clock 215. The clock 215 may comprise any means for displaying time known in the art, such as a liquid crystal display. The mobile unit 200 may determine the time displayed using any technique known in the art, including synchronizing itself to system time based on signals received from a base station. Methods for timing synchronization in CDMA communication systems suitable for use with the present invention are disclosed in U.S. Pat. No. 5,872,774, assigned to the same assignee of the present invention and incorporated herein by reference.

Mobile unit 200 may further include a battery 217. In an exemplary embodiment, battery 217 comprises a rechargeable battery disposed within the enclosure 201. It is contemplated that the battery 217 may be either removable or non-removable. Battery 217 may comprise any rechargeable power means, including nickel-cadmium, lithium-ion, or nickel metal hydride. In yet an exemplary embodiment, battery 217 is disposed such that contacts are available to recharge the battery 217 when the mobile unit 200 is placed in a recharging base which will be described in more detail below. The battery 217 may also be non-rechargeable.

Mobile unit 200 further includes receiving means RX 205. In an exemplary embodiment, RX 205 is configured to monitor pilot and paging signals and establish a bidirectional wireless connection when paged by the system.

As is appreciated by those of ordinary skill, transmitting places a great drain on the battery of a mobile unit. Hence, conserving battery power whenever possible is desirable in the mobile unit of the present disclosure. In an exemplary embodiment, the RX 205 is operatively coupled to the battery 217 such that the mobile unit 200 will remain in a low-power standby mode when not in use. The mobile unit may also save battery power by transmitting as infrequently as possible. The mobile unit 200 may also save battery power using a slotted paging mode as described in IS-95.

Mobile unit 200 may further include a position location processor 223. The position location processor 223 is configured to analyze signals received from the dispatch center through the receiver and determine the location of the mobile unit. The position location processor may be embedded within the control processor 212. Mobile unit 200 may further include memory 225 for storing the forbidden coordinates. As will be further described below, the coordinates can be programmed into the mobile unit by the dispatch center, or the park can be divided into predetermined regions with coordinates of the regions being hard-coded into the mobile unit. In the latter case, the dispatch center need only program the identities of the various predetermined regions to tailor them to the needs of each client.

CDMA-only Aspect

The mobile unit 200 may be configured to determine its location in a CDMA-only environment. It is contemplated that any CDMA-based position location techniques known in the art may be used in the present disclosure. For example, methods for performing position location on a strictly CDMA terrestrial system with no satellites required are known in the art. Such methods useful in the present application are disclosed in U.S. Pat. Nos. 5,646,632 and 5,900,838 to Khan, et al., in U.S. Pat. No. 6,134,228 to Cedervall, and in U.S. Pat. No. 6,034,635 to Gilhousen, and are incorporated by reference as though fully set forth herein.

GPS Aspect

The mobile unit may also be configured to determine its position when deployed in a GPS environment. It is contemplated that any GPS-based position location techniques known in the art may be used in the present disclosure, such as gpsOne. Further methods useful in the present disclosure include U.S. Pat. Nos. 6,081,229, 6,166,685, and 6,188,354 B1 to Soliman, et al.; 6,134,483 to Vayanos et al.; and 6,058,338 to Agashe et al., and are incorporated by reference as though fully set forth herein.

Mobile unit 200 may further include notification means 219. Notification means 219 may comprise various means known in the art, such as a beeper, vibrating unit, or visual indicators such as those found on pagers. In an exemplary embodiment, a complimentary unit carried by a parent or guardian may use the notification means 219 of the child's mobile unit to notify the child of predetermined events or emergencies. In addition, the parent device can provide notification of a condition of the child device, such as location, an indication of an emergency, or a band disconnect.

Mobile unit 200 may further include a conductor band 221. Conductor band 221 may also function as a strap for mobile unit 200. In an exemplary embodiment, mobile unit 200 is configured to notify the system if the conductor band 221 is removed or broken once attached to the wearer. In an exemplary embodiment, when conductor band 221 is removed or broken, the mobile unit 200 operates in a manner substantially similar to when the panic button 211 is activated. The conductor band may also be configured to function as an antenna for the mobile unit 200.

It is to be understood that the configuration of the mobile unit 200 is designed to be flexible according to the user's needs. Thus, the various elements as disclosed in FIG. 2A may be used separately or in combination as determined by one having the benefit of this disclosure. For example, if long power life is important to the user, the walkie-talkie configuration may be disadvantageous, as the speaker 207 and transmitter 203 may consume too much battery power. In such an embodiment, the speaker and transmitter may be omitted. Therefore, the mobile unit 200 may be embodied in a variety of configurations without departing from the inventive concepts disclosed herein.

FIG. 2B is a side view of a mobile unit 200 embodied in a watch-like configuration. The mobile unit 200 includes an enclosure 201 as shown and described above. The enclosure 201 may include a panic button 211.

The enclosure 201 may be fastened to the user with a wristband 221 that has a first fastener 227 and a second fastener 235. First fastener 227 may further include a conductive hook 229, and second fastener 235 may further include a conductive tongue 237. The wristband 221 includes a plurality of holes 231 and 233 configured to releasably engage second fastener 233 and first fastener 227, respectively. It will be recognized by those skilled in the art that the band may be connected many ways.

FIG. 2C is a perspective view of the mobile unit 200 of FIG. 2B. FIG. 2C shows that the wristband 221 may include a conductive path 241 disposed therein. It is contemplated that conductive path 241 may include one or more individual flexible traces. It is contemplated that when the conductive tongue 237 is engaged in one of the plurality of holes 231, a closed electrical circuit is established through trace 241, and thus around the user's body. In order to remove the mobile unit 200, the user will necessarily have to break this circuit, which may prompt the mobile unit to notify the dispatch center. The dispatch center may then notify the parent device that the mobile unit has been removed, and record the location of the mobile unit. It will be recognized by those skilled in the art that many fastener schemes may be employed to create the circuit functionality described above.

FIG. 2C also shows that the first fastener 227 may also include one or more connectors 239 for the programming of the mobile unit 200 and charging the battery 217.

FIG. 2D is a block diagram of a “child” or “parent” mobile unit apparatus. In an exemplary embodiment, the primary difference between a child mobile unit and a parent mobile unit may be in the way they are programmed at the dispatch center before dispensing them to park patrons. In an alternate embodiment, the hardware of a parent mobile unit may be different than the hardware of a child mobile unit. For example, a child mobile unit may not have a push-to-talk (PTT) button, or a parent mobile unit may lack a “panic button.”

In one aspect, the mobile unit may be configured to operate in two modes, a programming mode and a tracking mode. Thus, in such an embodiment, prior to operation in a tracking mode, the child mobile unit remains in a programming mode, such that programming commands or parameters can be sent through hardware interface (HW I/F) 228 to control processor 212. Control processor 212 then stores the received commands or parameters into memory 220. For example, such commands or parameters may include the physical coordinates of areas of an amusement park, including forbidden areas. Memory 220 may also include executable software or firmware codes executed by control processor 212. Though control processor 212 and location processor 218 are shown as being separate, they could also be integrated into a single processor.

During operation in the tracking mode, wireless signals are received and transmitted through diplexer 204 and antenna 202. Received signals are then processed by receiver 206. In an exemplary embodiment, receiver 206 is a CDMA receiver and performs frequency down-conversion, gain adjustments and demodulation of signals received from one or more base stations. Where receiver 206 is a CDMA receiver, it may further include a CDMA demodulator (not shown) for performing pseudorandom number (PN) despreading, Walsh code despreading, deinterleaving, and forward error correction (FEC) decoding. Searcher 208 coordinates the tracking of multipath signals by receiver 206. Such tracking of multipath signals is well known in the art. Receiver 206 and searcher 208 determine time offsets at which each of the multipath pilot signals is received and provides these time offsets to location processor 218. Though control processor 212 and location processor 218 are shown as being separate, they could also be integrated into a single processor. Based on the comparative times of arrival of the different signals, location processor determines the physical location of the child mobile unit. Location processor 218 provides this physical location to control processor 212, which compares the child mobile unit's physical location to the coordinates stored in memory 220.

It is contemplated that location processor 218 may be configured to use any position location techniques known in the art, such as CDMA- or GPS-based techniques. Thus, the mobile unit 200 may be configured to determine its location in one or more environments.

If the physical location is within a forbidden area, then control processor 212 sends an alert message to the dispatch center through one or more base stations. In an exemplary embodiment, the alert message is sent on the access channel using a format such as the SMS format, and identifies the child mobile unit. In an exemplary embodiment, the dispatch center identifies the corresponding parent mobile unit from a database, which may be located within the dispatch center. As is appreciated by those of ordinary skill in the art, the use of SMS avoids the overhead messages required to establish and tear down a traffic channel connection where only a small amount of information is being sent. Thus, to conserve battery power, traffic channels used by mobile units disclosed herein may be set up only for voice communications or if sustained, continuous position location communications are desired, as in the case where users are actively tracking a lost child.

In an alternate embodiment, the identity of the parent mobile unit is programmed into memory 220 of the child unit, and the alert message includes identification of a corresponding parent mobile unit. The dispatch center notifies the corresponding parent mobile unit by sending an alert message to the parent mobile unit on the paging channel.

In an exemplary embodiment, the parent mobile unit is of the same hardware configuration as the child mobile unit.

In an alternate embodiment, when control processor 212 determines that the location of the child mobile unit is within a forbidden area, the control processor 212 instead initiates a bidirectional voice connection with the corresponding parent mobile unit through one or more base stations and the dispatch center. To initiate a bidirectional voice connection, the child mobile unit sends an origination message. As discussed above, when initiating a bidirectional voice connection between the parent and child units, the dispatch center may identify the parent unit that corresponds to the child unit using either an internal database or extract the identity of the parent mobile unit from the contents of the origination message.

When the mobile unit transmits messages, control processor 212 provides transmit packets to traffic modulator (Traffic Mod) 214. Traffic modulator 214 performs forward error correction encoding and interleaving of the transmit packets and provides the resultant signal information to transmitter 216. In some CDMA systems, traffic modulator 214 may further perform orthogonal encoding of multiple reverse link channel signals, for example using Walsh codes. Transmitter 216 performs frequency up-conversion of the modulated signal and amplifies the up-converted signal for transmission through diplexer 204 and antenna 202.

In an exemplary embodiment, a mobile unit may establish a bidirectional voice connection with one or more other mobile units through the dispatch center. Such a bidirectional voice connection may be established, for example, when a panic button or push-to-talk button is pressed on a mobile unit. Once a bidirectional voice connection is established between two mobile units, audio signals such as speech are input into microphone (MIC) 226 and output through speaker (SPKR) 224. The audio signals are converted into electrical signals in speaker 226 and provided to vocoder 222. Vocoder 222 performs analog-to-digital conversion and then compresses the resulting digital audio data into smaller voice data packets. The voice data packets from vocoder 222 are provided to control processor 212, where they are sent through traffic modulator 214 and subsequently transmitted to the dispatch center. In the opposite direction, receiver 206 extracts voice data packets from the signals received from the dispatch center. The voice data packets from receiver 206 are provided to control processor 212, which then provides the voice data packets to vocoder 222. Vocoder 222 provides the received voice data packets back into a digital audio data. Vocoder 222 then converts the digital audio data into analog audio signals using digital-to-analog conversion. The resultant analog audio signals are then output through speaker 224.

Referring now generally to the configuration of a mobile unit 200 according to the present invention, it is contemplated that mobile unit 200 may be configured advantageously in a variety of manners depending upon its ultimate use. For example, an embodiment may be designed to utilize a frequency that is not used by local cellular or PCS systems.

It is contemplated that the memory 220 of the mobile unit 200 may be programmed with a set of coordinates in a variety of manners. For example, the coordinates may be provided as forward link data received by the mobile unit 200 and programmed into memory 220 by the location processor 218. Alternatively, the coordinates may be programmed into the memory 220 by a dispatch center through connectors 239 as described below. Furthermore, the coordinates may be provided as predetermined coordinates burned into a ROM. In such a case, the location processor 218 may be programmed to read a set of coordinates previously programmed into the memory 220.

When the location processor 218 determines that the mobile unit 200 has entered a forbidden area, the mobile unit may be configured to provide a reverse link signal to the base system. Additionally, the mobile unit 200 may be configured to provide its location through a reverse link signal when prompted by the base system.

Furthermore, a frequency may be selected that is used only by the base system, thus ensuring that mobile units will not operate out of the selected coverage area. In order to make theft of the units less attractive, the mobile units may be configured such that they will not operate at a different frequency than that used by the park. Alternatively, the mobile units may be configured to operate only using wireless parameters unique to the park, such as park identification information transmitted over the sync channel or specific pilot PN offsets. Thus, if the system's coverage includes a park, because the mobile unit works only with the park's infrastructure system, park patrons will have little incentive to steal the mobile units. Also, the dispatch center may be configured to alert park staff when a mobile unit leaves the park area. Additionally, the mobile unit may be configured to determine when it has left the coverage area and automatically sound an audible alert when leaving the park premises.

Infrastructure

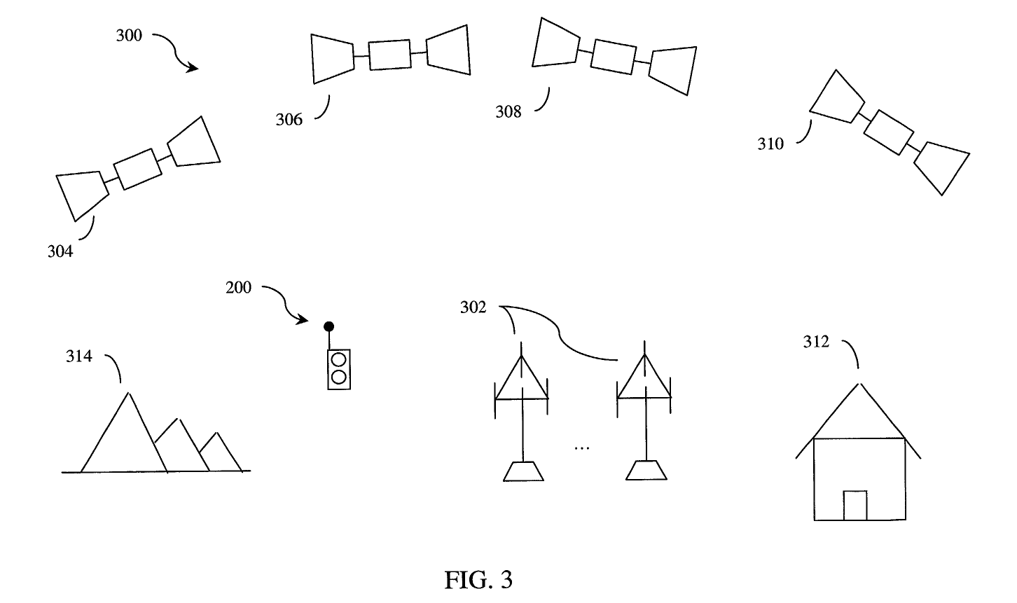

FIG. 3 is a diagram showing an illustrative implementation of a wireless communication system 300 according to the present invention. System 300 includes mobile unit 200 and an external signal source, such as a plurality of base stations 302 or satellites 304, 306, 308, and 310 of a wireless code division multiple access (CDMA) communication system. The communication system may be surrounded by buildings 312 and ground-based obstacles 314.

The base station 302 and mobile unit 200 may be disposed in a GPS (Global Positioning System) environment having several GPS satellites, of which four are shown (304, 306, 308, and 310). Such GPS environments are well known. See for example Hofmann-Wellenhof, B., et al., GPS Theory and Practice, Second Edition, New York, N.Y.: Springer-Verlag Wien, 1993. Those of ordinary skill in the art will appreciate that the present teachings may be applied to other communication systems, such as advanced mobile phone system (AMPS), Global system for mobile communications (GSM), etc. without departing from the scope of the present invention.

In an exemplary embodiment, the communication system 300 may be operatively deployed in an amusement park. Thus, obstacles 312 and 314 may comprise attractions typically found in an amusement park.

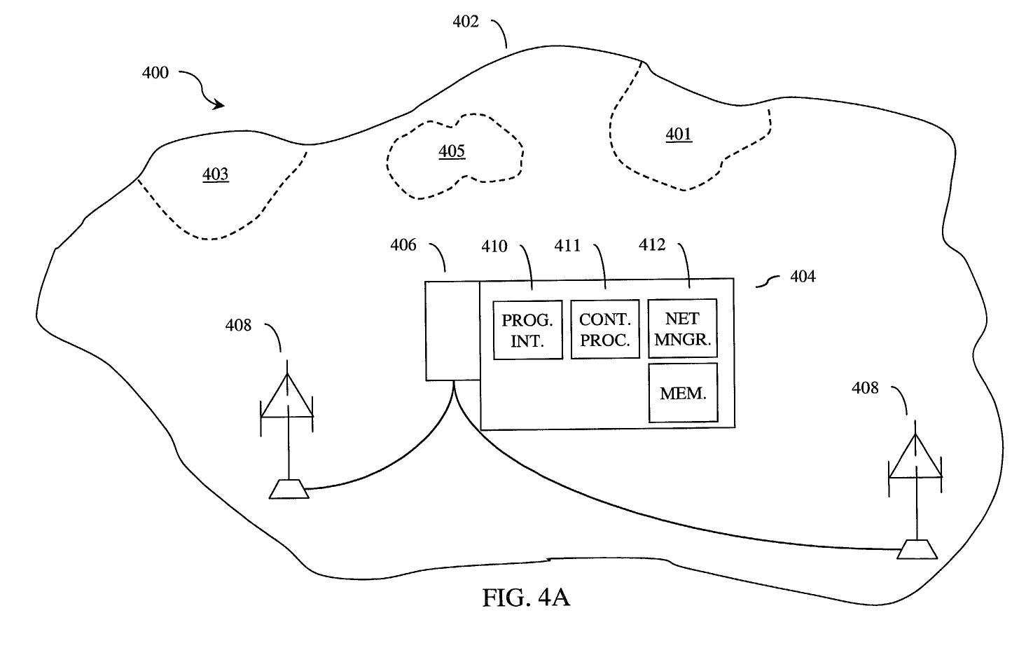

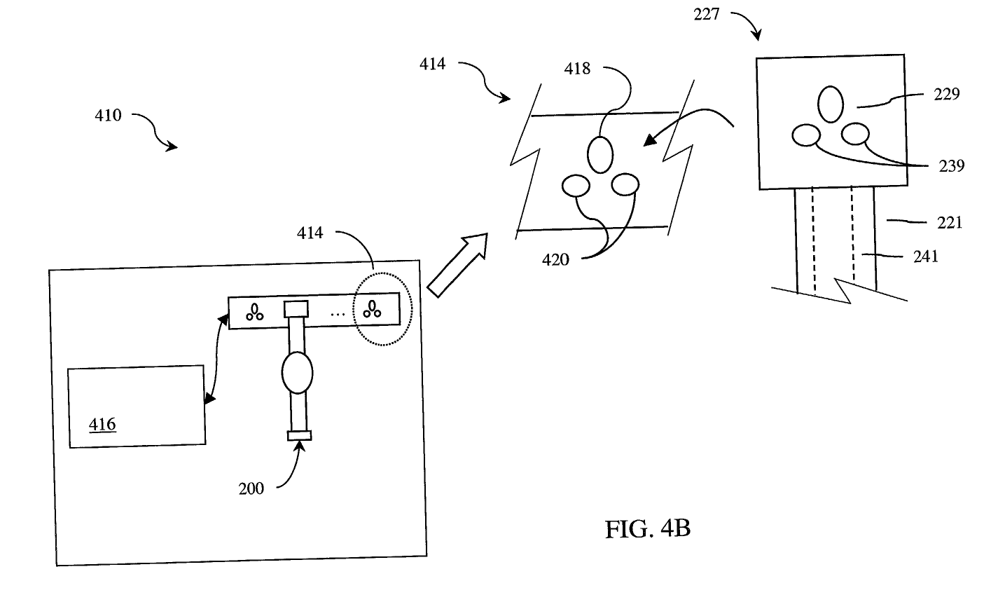

FIG. 4A is a diagram of a system infrastructure 400 according to one disclosed embodiment. It is contemplated that the infrastructure 400 may be operatively deployed within a predetermined area 402. In an exemplary embodiment, area 402 may comprise the boundary of an amusement park. It is contemplated that the present invention may be used in a variety of areas. For example, the present invention may be used in shopping malls, schools, museums, zoo, miniature golf courses, or a beach.

FIG. 4A includes a dispatch center 404. Dispatch center 404 may include a wide variety hardware and software configured to program and communicate with multiple mobile units.

Dispatch center 404 may include a transmitter 406 configured to transmit pilot signals used for timing by mobile devices. Transmitter 404 may also be configured to transmit arbitrated net traffic corresponding to various sub-nets. The configuration of a transmitter will be described in more detail below.

Dispatch center 404 may further include a net manager 412 and a programming/charging interface 410. Interface 410 is configured to house a plurality of mobile units and prepare mobile units for use by charging their batteries and programming the mobile units for use. Interface 410 will be discussed in more detail below.

System 400 further includes a plurality of transmitting antennae 408 operatively deployed throughout area 402. The coverage area 402 may further include forbidden areas, such as forbidden areas 401, 403, and 405. Any area outside of area 402 may also serve as a forbidden area.

Antennae 408 are preferably located about area 402 to allow position location of a mobile unit by triangulation and round trip delay (RTD) information. The configuration of antennae 408, as well as location methods, will be discussed further below.

Referring now to FIG. 4B, a functional illustration of a programming/charging interface 410 according to the present invention is shown.

Interface 410 includes at least one receptacle 414 configured to receive a mobile unit 200 according to the present invention. As can be seen by inspection of the detailed illustration of the receptacle 414, in an exemplary embodiment the receptacle 414 may include a recess 418 configured to receive hook 229, and connectors 420 configured to electrically couple with corresponding connectors 239 of the mobile unit (as shown in FIG. 2C). As can be seen by inspection of FIG. 4B, the mobile unit 200 and receptacles 414 are preferably configured such that electrical coupling is achieved between the two by hanging the mobile unit 200 by the hook 229 from receptacle 414. Such coupling may be achieved through the use of complimentary connectors known in the art such that programming or charging of the mobile unit may be achieved. The interface 410 and receptacle 414 may be configured such that contact between the mobile unit and receptacle may be made by simply hanging the mobile unit on the receptacle.

When mated with a mobile unit, receptacle 414 is configured to provide power for recharging the battery 217 of the mobile unit 200, and for programming through the conductive portions of the wristband 241.

The interface 410 may further include a programming unit 416. Programming unit 416 is operatively coupled to the receptacle 414 and is configured to program a mobile unit mated in the receptacle to provide the functionality of the present invention. Programming unit 416 may comprise computer hardware and software standard in the art, such as a personal or laptop computer.

Programming unit 416 is preferably configured to program mobile units coupled in corresponding receptacles. The receptacles 414 may be numbered such that software can tell an operator which mobile unit is being programmed. Additionally or alternatively, the programming unit 416 could read a unique identification number corresponding to each mobile unit and displayed prominently on each mobile unit. The programming unit 416 may configure each mobile unit before the mobile unit is provided to the park patron.

It is contemplated that the programming unit will be configured to program the mobile units. In an exemplary embodiment, it is contemplated that a group of mobile units may be programmed together as a functional “sub-net” corresponding to a predetermined group, such as a family, for example. A method and apparatus for providing such a sub-net is disclosed in U.S. Pat. No. 5,912,882, assigned to the same assignee as the present application, and is incorporated by reference herein.

Thus, multiple mobile units may be programmed whereby one mobile unit is programmed to have functions associated with a parent, and the remaining mobile units are programmed to have features associated with children. Thus, the parent units may be substantially identical to the child units in terms of the hardware, but may have different functionality programmed into the different units.

For example, when the panic button on a child unit is pressed, that child unit notifies the dispatch center, which notifies the corresponding parent unit. When the child unit enters an area of the park that the parent has identified as forbidden, the same or a similar result follows. When a group of mobile units are being used in push-to-talk sub-net mode, each child can generally broadcast voice messages to the others in his family or group. Another child cannot broadcast to everyone else until the first child releases the PTT button. However, when a parent presses the PTT button, this overrides any child PTT button press and immediately broadcasts the parent's voice to the mobile units in the family or group. As can be seen, a wide variety of functionality may be programmed into mobile units of the present disclosure.

Additionally, it is contemplated that the mobile units may have selective functionality programmed into them. In other words, a customer may order varying levels or categories of mobile unit features and functions.

Furthermore, if the customer desires to have a sub-net defined, other features may be available. For example, the mobile units may be programmed to provide prioritization identification among members of the sub-net, and selective features for various members of the sub-net such as those described above. Additionally, the mobile units may also have the forbidden coordinates mentioned above programmed into them by the programming unit, and various members of the sub-net may have differing forbidden coordinates. For example, different children may have different areas they are allowed to go into, and their mobile unit may be programmed correspondingly. It is contemplated that the programming unit may also program a standard set of forbidden coordinates into the mobile units, such as exits or employee-only areas of the park. Additional coordinate sets may be predetermined by the owners of the park and may correspond to criteria such as age, weather, pricing structure, and the like.

After the user is provided with mobile units programmed according to their needs, the mobile units are then attached to their corresponding users who may then venture into the coverage area.

As mentioned above, one use of the present invention is to track children throughout a coverage area such as a park. If a child enters into a forbidden zone, the child's mobile unit immediately initiates a connection to the dispatch center. The dispatch center then determines the corresponding parent unit(s) and notifies those units. Such a notification may be accomplished by sending a page message addressed to each corresponding parent unit. Each corresponding parent unit then alerts its wearer by beeping or vibrating and perhaps displaying a written message identifying the triggering event.

The dispatch center may also determine the position of the child unit and perform one or more helpful tasks. For example, the dispatch operator may communicate verbally with the parent unit to provide directions to the location of the child unit. If the mobile unit 200 includes an alphanumeric or graphical display, the directions may be also displayed on the parent's mobile unit by sending a page from the dispatch center to the parent. Additionally, where a mobile unit 200 includes the appropriate hardware such as microphone and speaker, a voice link may be established between the parent unit and the child unit to allow direct communication.

Furthermore, the parent can go to the dispatch center and see a map of the coverage area showing the location of their child units. Additionally, if the dispatch center or parent suspect a kidnapping, such as if the wristband has been disconnected, park security personnel may be summoned immediately to the point where the disconnection occurred to locate the child.

Location Detail

The mobile unit 200 is preferably configured to determine its location within the coverage area. As is appreciated by those of ordinary skill in the art, several methods are available to accomplish location determination.

For example, methods for performing position location on a strictly CDMA terrestrial system with no satellites required are known in the art. For example, methods useful in the present invention are disclosed in U.S. Pat. Nos. 5,646,632 and 5,900,838 to Khan, et al., in U.S. Pat. No. 6,134,228 to Cedervall, and in U.S. Pat. No. 6,034,635 to Gilhousen.

Furthermore, the present invention may be configured to allow the position of a mobile unit to identified using a minimum number of GPS satellites. One aspect of such a configuration will now be disclosed.

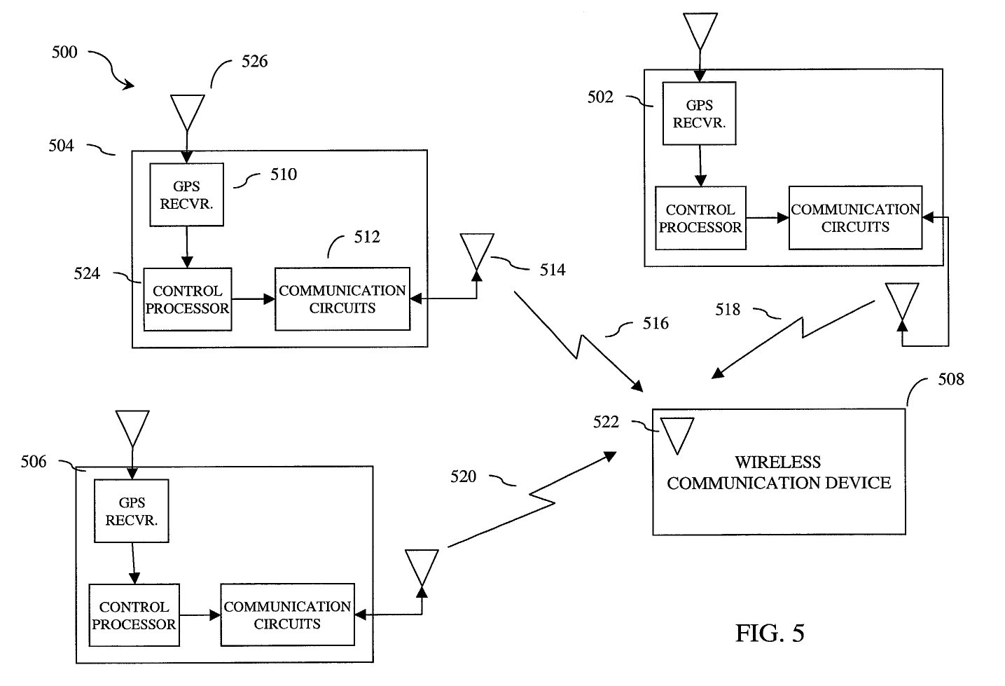

FIG. 5 is a simplified representation of a wireless communications system 500 according to the present invention. System 500 includes first, second, and third base stations 502, 504, and 506, respectively, and a wireless communication device 508. As can be seen by inspection of FIG. 5, each base station comprises: a GPS transceiver/time unit 510; processing circuitry, such as a control processor 524; a GPS antenna 526, communication circuits 512; and communication antennas 514. It will be understood by those of ordinary skill in the art that the control processing circuitry may be a general purpose computer, a microprocessor, micro-computer, dedicated state machine, dedicated discrete hardware circuitry, application specific integrated circuit (ASIC), or any other circuitry that allows the functions described as being performed by the control processor to be performed.

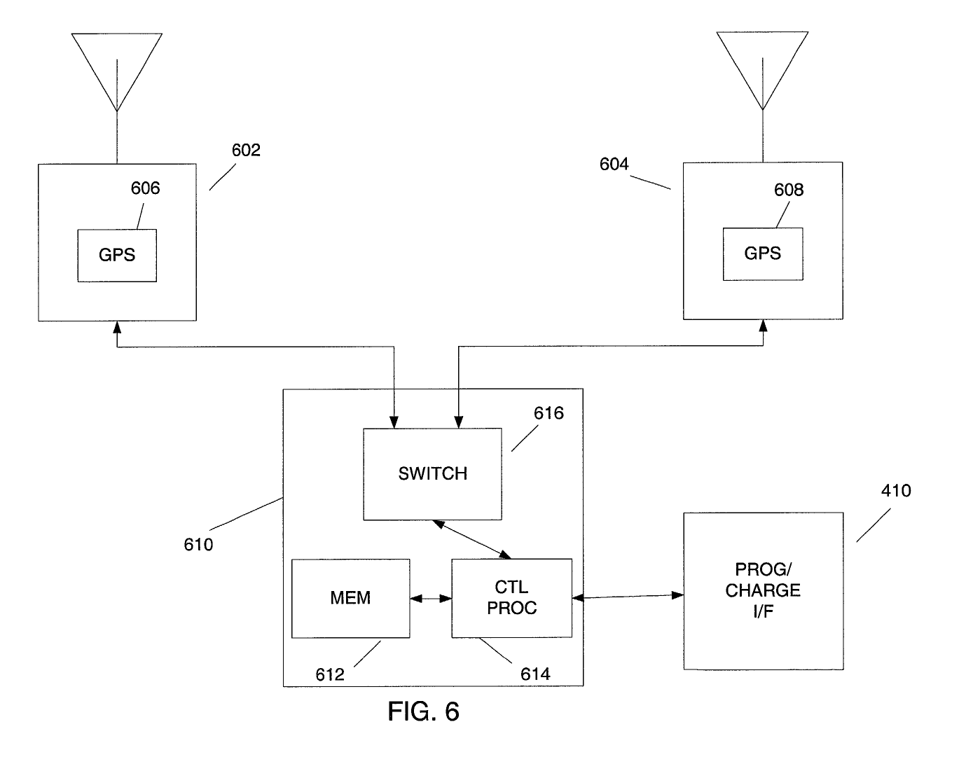

FIG. 6 is a block diagram of one aspect of a disclosed wireless infrastructure apparatus. Programming/charging interface 410, described in FIG. 4B, communicates through a control process 614 within dispatch center 610. Though shown as separate elements, programming/charging interface 410 could be integrated into dispatch center 610. Programming/charging interface 410 provides information regarding assignments of mobile units to each other. A common assignment is a single parent mobile unit and one or more child mobile units. Another assignment is two parent mobile units assigned to one or more child units. Many other arrangements of mobile unit assignments are also possible.

Control processor 614 stores assignment information received from programming/charging interface 410 into memory 612. Signals transmitted by mobile units are received by one or more base stations (602 and 604). Though two base stations are shown, the wireless infrastructure apparatus will generally include a greater number of base stations. This is because a mobile unit must generally receive signals from at least four base stations in order to accurately compute its own position. In order to allow the base stations to transmit synchronized signals, each may include a GPS receiver 606 and 608. Base stations 602 and 604 extract data information from the wireless signals received from the mobile units and send the extracted information to dispatch center 610. Within dispatch center 610, a data switch 616 acts as the interface to the base stations 602 and 604. The switch provides control messages to control processor 614.

For example, when a panic button alert message is received from a child remote unit, control processor 614 accesses memory 612 in order to identify the corresponding parent remote unit. Control processor 614 then sends an alert message through switch 616 and base stations 602 and 604 to the corresponding parent remote unit, prompting the parent remote unit to alert its user. In an exemplary embodiment, a panic button alert message contains the location of the originating remote unit, and the location information is sent to the corresponding parent unit with the alert message. The parent unit may then display the information in a map grid format or perhaps by name of park section.

When a voice connection origination message is received from a remote unit, control processor 614 accesses memory 612 in order to identify the remaining remote units in a “virtual subnet” of which the remote unit is a member. Control processor 614 formulates origination messages to be sent through switch 616 and base stations 602 and 604 to establish a bidirectional voice connection with each of the remaining virtual subnet remote units. Once the connections are established, the members of the virtual subnet can communicate through their remote units in “walkie-talkie” style by using their push-to-talk buttons.

As can be seen from the above description, a novel and useful system and apparatus has been disclosed which allows the locations of mobile units to be tracked within a predefined area. However, other uses of the disclosed system are also possible.

The disclosed system may be used to monitor a user's presence in regions other than forbidden zones. For example, if the disclosed system is utilized in an amusement park setting, the system may be configured to monitor traffic in various regions of the park, in addition to detecting movement into forbidden areas.

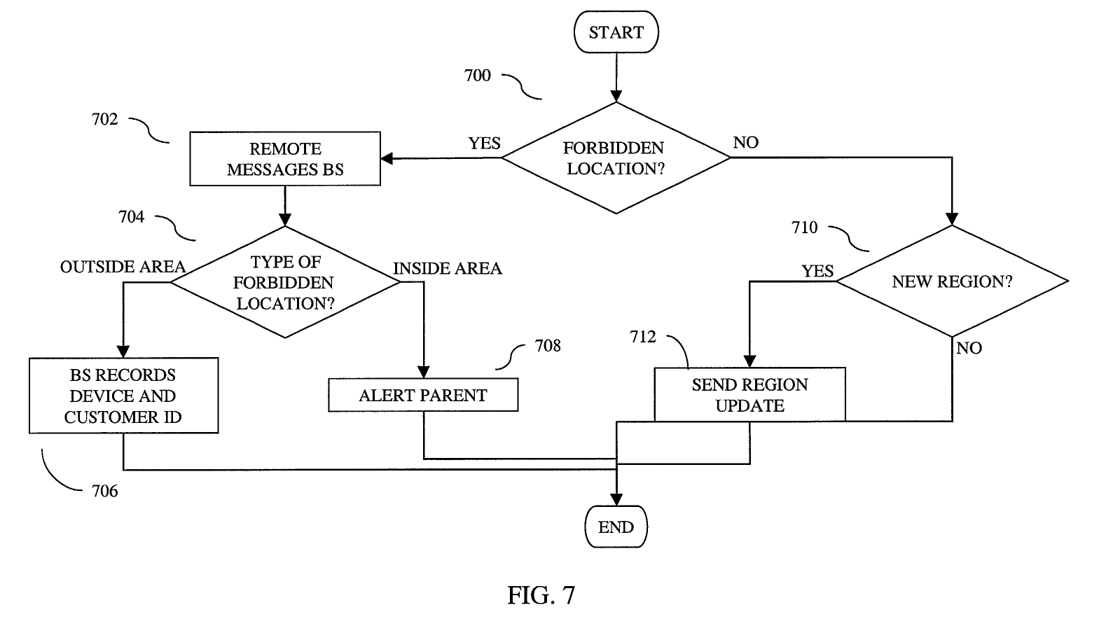

FIG. 7 is a flowchart of a method for determining traffic in different regions. The process begins in query 700, where a mobile a mobile unit configured in accordance with the present disclosure determines its' location and determines whether it has entered a forbidden zone. If the remote unit is in a forbidden zone, a message is sent to a base station in step 702.

After receiving the message from the mobile unit, the base station in step 704 then determines the type of forbidden zone. If the base station determines that the mobile unit has traveled outside of the boundaries of the area, such as if the unit has been taken beyond the boundaries of the park, then the base station may record the identity of the user and mobile unit in step 706. If the unit is in an internal forbidden area, such as an area within the park designated as forbidden to the child wearer, the base station may then notify the parent unit in step 708.

If the result of query 700 is that the location is not a forbidden location, then the mobile unit may be configured to compare its present location to a predefine list of regions. The mobile unit may also be configured to store its most recently determined location. In query 710, the mobile unit may then compare its present location against its most recent location. If the mobile unit determines that it has entered a new region, the mobile unit may then send a region update notification to the base station. It is contemplated that through this procedure, the user of the system may track traffic flow within their establishment. This information may be useful for marketing or other purposes.

Though the acts of FIG. 7 are shown as being performed as one method, it is contemplated that the separate branches of query 700 may be performed separately or in combination. For example, the branch including query 704 may be useful if performed separately if the user does not wish to monitor traffic in non-forbidden zones.

The previous description of various embodiments, which include preferred embodiments, is provided to enable any person skilled in the art to make or use the present invention. The various modifications to these embodiments will be readily apparent to those skilled in the art, and the generic principles defined herein may be applied to other embodiments without the use of the inventive faculty. Thus, the present invention is not intended to be limited to the embodiments shown herein but is to be accorded the widest scope consistent with the principles and novel features disclosed herein.

What is claimed is:

1. A mobile unit configured to communicate with a wireless dispatch center comprising:
a wearable enclosure;
a transmitter and receiver disposed within said enclosure; and
a position location processor configured to analyze signals received from the dispatch center through the receiver and determine the location of the mobile unit.

2. The mobile unit of claim 1, further comprising a strap for attaching said enclosure to a wearer, wherein said position location processor is configured to detect when said strap is disconnected and notifies the dispatch center of the disconnection using a signal transmitted from said transmitter.

3. The mobile unit of claim 1, further comprising a push-to-talk (PTT) button for facilitating communications with more than two users.

4. The mobile unit of claim 1, further comprising a panic button for automatically communicating with said dispatch center when activated.

5. The mobile unit of claim 1, further comprising a battery disposed within said enclosure such that contacts of said battery are available when said mobile unit is placed in a recharging base.

6. The mobile unit of claim 5, wherein said battery comprises a rechargeable battery.

7. The mobile unit of claim 1, wherein said position location processor is configured to determine its location using CDMA-based techniques.

8. The mobile unit of claim 1, wherein said position location processor is configured to determine its location using GPS-based techniques.

9. The mobile unit of claim 2, wherein said strap includes a conductor band.

10. The mobile unit of claim 9, wherein said conductor band also functions as an antenna.

11. The mobile unit of claim 2, further comprising notification means for notifying users of an event.

12. The mobile unit of claim 1, wherein said enclosure comprises a watch-like configuration.

13. The mobile unit of claim 1, further including memory for storing forbidden coordinates.

14. The mobile unit of claim 13, wherein said mobile unit is configured to notify said dispatch center if said mobile unit enters a location within said forbidden coordinates.

15. The mobile unit of claim 14, wherein said notification comprises an alert message sent on an access channel of a CDMA system using a SMS format.

16. The mobile unit of claim 13, wherein said memory further includes the identity of a parent unit.

17. The mobile unit of claim 14, wherein said mobile unit is configured to notify said dispatch center if said mobile unit enters a location within said forbidden coordinates, and said notification further includes the identity of said parent unit.

18. The mobile unit of claim 13, wherein said mobile unit is configured to initiate a bidirectional voice communication if said mobile unit enters a location within said forbidden coordinates.

19. The mobile unit of claim 3, wherein said mobile unit is configured to initiate a bi-directional voice communication if said PTT is activated.

20. The mobile unit of claim 4, wherein said mobile unit is configured to initiate a bi-directional voice communication if said panic button is activated.

21. The mobile unit of claim 1, wherein said mobile unit is configured to operate on a frequency which is inoperable outside of a pre-determined coverage area.

22. The mobile unit of claim 21, wherein said mobile unit is configured to provide an alert to said dispatch center when located outside of a pre-determined coverage area.

23. The mobile unit of claim 21, wherein said mobile unit is further configured to provide an audible alert when located outside of a pre-determined coverage area.

24. A communication system for tracking individuals comprising:
a dispatch center operatively coupled to a transmitter and a plurality of antennae deployed about a predetermined area; and
a charger/programming interface operatively disposed within said dispatch center and configured to receive one or more mobile units, wherein said interface is configured to program said mobile units with predetermined coordinates.

25. The system of claim 24, wherein said comprises a CDMA-compliant system.

26. The system of claim 24, wherein said interface comprises at least one receptacle configured to receive said one or more mobile units.

27. The system of claim 26, wherein said at least one receptacles are further configured to receive said one or more mobile units in a hanging position.

28. The system of claim 26, wherein said at least one receptacles are further configured to charge said one or more mobile units in a hanging position.

29. The system of claim 26, wherein said at least one receptacles are further configured to program said one or more mobile units in a hanging position.

30. The system of claim 26, wherein said dispatch center further includes a programming unit configured to program said one or more mobile units.

31. The system of claim 30, wherein said dispatch center further includes a programming unit configured to provide a sub-net for said one or more mobile units.

32. The system of claim 30, wherein said dispatch center is configured so as to program said one or more mobile units such that one of said one or more mobile units corresponds to a parent unit, and one of said one or more mobile units corresponds to a child unit.

33. The system of claim 32, wherein said dispatch center is further configured to notify said parent unit if one of said child units provides an alert.

34. The system of claim 32, wherein said dispatch center is further configured to program different forbidden coordinates into said parent and child units.

35. The system of claim 32, wherein said dispatch center is further configured to notify said parent unit if one of said child units enters a location of a forbidden coordinate.

36. The system of claim 35, wherein said notification includes the location of the child unit providing said notification.

37. The system of claim 35, wherein said notification includes a voice link to the child unit providing said notification.

38. A method for tracking a mobile unit comprising:
storing forbidden coordinates into the mobile unit;
comparing, by said mobile unit, the location of said mobile unit to said forbidden coordinates; and
notifying a dispatch center, by said mobile unit, if said mobile unit is proximate to said forbidden coordinates.

39. The method of claim 38, further including the act of determining if said mobile unit is in a new region if said mobile unit is not proximate to a forbidden coordinate.

40. A method of sending an alert message, comprising the steps of:
receiving synchronized signals from a plurality of transmitters;
determining a location based on the signals;
comparing said location to a forbidden location stored within the mobile unit; and
sending an alert message to a dispatch center based on said comparing.

41. A computer-readable medium containing computer-executable instructions for tracking a mobile unit that, when executed, comprise the steps of:
storing forbidden coordinates into the mobile unit;
comparing, by said mobile unit, the location of said mobile unit to said forbidden coordinates; and
notifying a dispatch center, by said mobile unit, if said mobile unit is proximate to said forbidden coordinates.
